(19) United States
(12) Patent Application Publication
(10) Pub. No.: US 2010/0009610 A1
(43) Pub. Date: Jan. 14, 2010

(54) NON-MOTORIZED HAND MANIPULATABLE SURFACE MODIFYING TOOL AND METHOD OF CONVERTING THE SAME

(75) Inventors: Allen J. Rivard, White Bear Lake, MN (US); David R. Dow, West Lakeland, MN (US); Galen A. Fitzel, St. Paul, MN (US); John G. Petersen, Center City, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/170,860

(22) Filed: Jul. 10, 2008

(51) Int. Cl. B24D 11/00; B23P 6/00

(52) U.S. Cl. 451/526; 29/402.08

(57) ABSTRACT

Disclosed is a non-motorized hand manipulatable surface modifying tool and method that facilitates improved surface modifying efficiency and ease of conversion to any one of several different surface treating assemblies. Included is a generally lightweight, low density supporting body assembly made of a block of generally rigid plastic foam material that is sized and shaped to allow a user to manipulate the tool by hand to modify a surface while retaining its shape under hand applying pressure; and a generally flexible surface modifying article.

### BACKGROUND

The present description is directed to providing a non-motorized hand manipulatable surface modifying tool and method. More particularly, the present description is directed to providing a non-motorized hand manipulatable surface modifying tool and method that facilitate improved surface modifying efficiency and ease of conversion to any one of several different surface treating assemblies.

Surface modifying devices, such as hand held tools, have been used for working or modifying a wide variety of surfaces. For example, when fabricating a structure, such as a wall or ceiling, it is sometimes necessary to utilize a sanding device to smooth the surface of the structure. For example, interior walls of office building and houses typically use drywall panels. The drywall panels may be attached to wood or metal frames to form interior walls and ceilings. Joints or seams are formed along edges where the different dry wall panels are juxtaposed to each other. Typically, the seams are covered with a compound and smoothed. This is to give the appearance that the seams do not exist and provide a wall that is otherwise seamless, smooth, and flat.

Treating compounds are applied wet to the drywall to fill in the seams and any gaps between the drywall panels. Once dry, the compounds are typically sanded smooth. One known type of device for sanding includes a hand held tool assembly that includes a sanding block for holding conventional sanding paper wrapped over the block. Wrapping and securing of the sanding paper must be done carefully to avoid improper mounting that may lead to damaged sanding paper during mounting and use and less than desirable sanding results. Other known approaches tend to use disposable sanding devices, such as sanding sponges. This latter group of sanding device has at least an abrasive surface integral therewith and typically different abrasive surfaces are associated with different surfaces of the sanding device. Once the abrasive article is used, the entire article is typically disposed.

Given the increasing and relatively high costs of components in today's environment, disposable is a less attractive commercial option. Hence, there is a desire not to dispose of the working tools. Accordingly, it is desirable to make sanding less costly by being able to reuse as many components as possible. In addition, there is a desire to provide for hand sanding operations that are an improvement over many of the known sanding block and sanding paper combinations noted above and by making the changing of components quick and reliable. This is a significant consideration because different sanding grades are typically used to sand and thus repeated efforts are required to replace these sanding papers during a typical drywall finishing operation.

In addition, some drywall finishing operations may require other surface modifying applications besides sanding, such as, cleaning, painting, and the like. Accordingly, costs for treating drywall increase due to different specialty tools and surface modifying assemblages being required before a wall may be wallpapered or painted. As a consequence, there is an interest in making such operations less expensive and time consuming. As such there is continuing interest in seeking improvements in addressing the foregoing issues in an expeditious and cost effective manner.

### SUMMARY

The present description is directed to a non-motorized hand manipulatable surface modifying tool. The tool comprises: a generally lightweight, low density supporting body assembly including at least a first major surface and being made of a block of generally rigid plastic foam material that is sized and shaped to allow a user to manipulate the tool by hand to modify a surface while retaining its shape under hand applying pressure; and a generally flexible surface modifying article that is releasably connected to at least the first major surface so as to be generally coextensive with at least a portion thereof.

The present description is directed to a method of converting a non-motorized hand manipulatable surface modifying tool. The method comprises: providing a generally lightweight, low density supporting body assembly including at least a first major surface and being made of a block of generally rigid plastic foam material that is sized and shaped to allow a user to manipulate the tool by hand to modify a surface while retaining its shape under hand applying pressure; and a generally flexible surface modifying article that is releasably connected to at least the first major surface so as to be generally coextensive with at least a portion thereof; removing the surface modifying article by peeling the surface modifying article from the supporting body assembly; and attaching another surface modifying article to the first major surface.

One aspect of the present description is for providing a non-motorized hand manipulatable surface modifying tool that is highly versatile and facilitates ease of worker manipulation while treating a working surface.

Another aspect of the present description is for accomplishing the above in a manner that provides a lightweight and rigid foam body assembly that may be provided with a releasable foam backing material having an abrasive coating.

Another aspect of the present description is for accomplishing the above in a manner that provides a quick and reliable changing or conversion of the tool with different surface modifying articles.

Another aspect of the present description is to accomplish the above by improving the efficiency of surface modification, through the use of relatively large and lightweight modifying surfaces in a manner that reduces user fatigue.

Another aspect of the present description is to accomplish the above by minimizing the tearing of surface modifying sheets, such as abrasive sanding sheets during surface treating.

Another aspect of the present description is to accomplish the above in a manner that is cost effective to manufacture, assemble, and use.

The aspects described herein are merely a few of the several that can be achieved by using the present description. The foregoing descriptions thereof do not suggest that the present description must only be utilized in a specific manner to attain the foregoing aspects.

### BRIEF DESCRIPTION OF THE DRAWINGS

FIG. 1 is a perspective view of one exemplary embodiment of a non-motorized hand manipulatable surface modifying tool.

FIG. 2 is an elevation view of the non-motorized hand manipulatable surface modifying tool of FIG. 1.

FIG. 3 is a view similar to FIG. 2, but with the components of the non-motorized hand manipulatable surface modifying tool in an exploded arrangement.

FIG. 4 is a view similar to FIG. 1, illustrating another exemplary embodiment of a non-motorized hand manipulatable surface modifying tool according to the present description.

FIG. 5 is an end view of another exemplary embodiment of the present description.

### DETAILED DESCRIPTION

The present description is directed to a non-motorized hand manipulatable surface modifying tool and method that facilitates converting the same. The words “a,” “an,” and “the” are used interchangeably with “at least one” to mean one or more of the elements being described. By using words of orientation, such as “top,” “bottom,” “overlying,” “front,” and “back” and the like for the location of various elements in the disclosed articles, we refer to the relative position of an element with respect to a horizontally-disposed body portion.

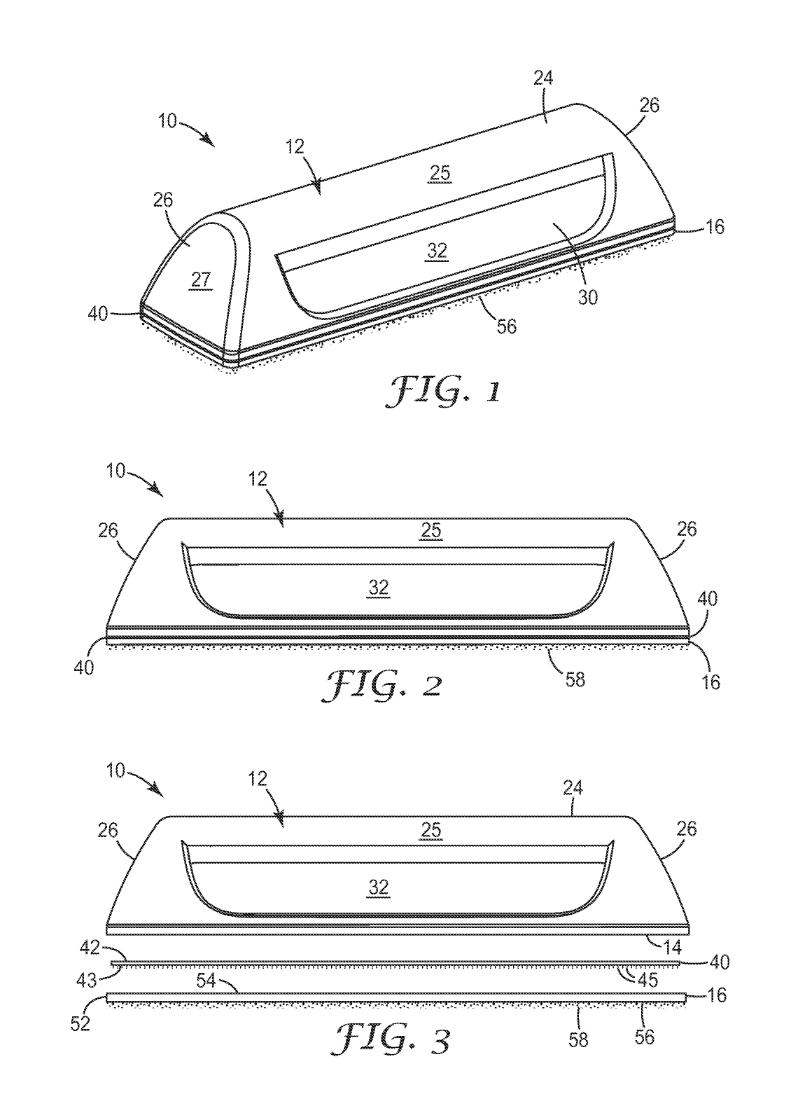

FIGS. 1-3 illustrate one exemplary embodiment of a surface modifying mechanism 10, such as a non-motorized hand manipulatable surface modifying tool 10 for treating a generally planar working surface, such as a wall, ceiling or other similar structures. While a non-motorized hand manipulatable surface modifying tool 10 is described, the present description envisions that a variety of hand tools may be used within the spirit and scope of the present description. In addition, while abrading a surface as by sanding is described hereinafter, the present description envisions other surface treating methods, such as cleaning, polishing, deburring, painting and the like.

FIGS. 1-3 illustrate one exemplary embodiment of a non-motorized hand manipulatable surface modifying tool 10. In the exemplary embodiment, there is provided a generally lightweight, rigid, and low density supporting body assembly 12 including at least a first major surface 14 and a surface modifying article 16 coupled thereto. The supporting body assembly 12 may be made of a one-piece block 12 of generally lightweight and rigid plastic foam material. By being lightweight and rigid, the supporting body assembly 12 is able to be more easily manipulated by a user during sanding operations. This lessens user fatigue. Also, such a supporting body assembly 12 retains its shape under hand applying pressure and thereby more evenly distributing the forces applied by the user on the surface modifying article 16 over the working surface.

In the exemplary embodiment, the supporting body assembly 12 may be made of polymeric foam block that is generally lightweight, rigid and has low density. In this regard, the polymeric low density foam material may be in a density range of about 2.50 pounds/ft.³ to about 6.00 pounds/ft.³ so as to provide the relative lightweight and rigid characteristics noted. If the density is below this range then the material may be abraded away too easily by hitting adjacent walls or its surface may assume a permanent set because such a surface rested against a non-planar surface.

A variety of synthetic polymeric foam materials may be used. In the exemplary embodiment, the polymeric foam material may be from a group of materials that consists of polystyrenes, polyurethanes, polyolefins, polyesters and combinations thereof. While the supporting body assembly 12 is described as being rigid, it will be understood that there may be some flexure such that it is capable of retaining its shape during abrading a surface. As such, the body assembly will retain its shape during normal use. In the exemplary embodiments using polystyrene and/or, polyurethane, the latter may be closed foam materials, although open foam materials may be used so long as they can possess similar mechanical properties and function similarly as closed foam materials.

The block of supporting body assembly 12 may be made as one-piece construction that may comprise a generally oblong shape and defines a generally planar first major surface 14. The supporting body assembly 12 includes a generally convex upper body portion 24 having a surface 25 that is sized to allow a user to grasp the same with a hand and use to sand a working surface. In the exemplary embodiment, the supporting body assembly 12 may be about 11 inches long and about 5 inches wide. These dimensions are for purposes of illustration and are not considered limiting. As noted, a variety of sizes and shapes may be used depending on the kinds and contours of surfaces to be treated. Longitudinal end portions 26 of the supporting body assembly 12 converge or are sloped as illustrated. Such sloping for the end portions 26 is for providing additional surface treating surfaces as well as for providing the ability to get close to the adjacent wall as will be described. The rigid supporting body assembly 12 also provides support for facilitating peeling of the surface modifying article 16 therefrom, particularly at the rounded corners thereof.

The supporting body assembly may include a handle 30 integral therewith. The handle 30 in the exemplary embodiment may be formed as elongated recess 32 in opposite side walls of the upper body portion that extend along the longitudinal extent of the supporting body assembly 12. The recess 32 may be sufficiently deep and long so as to allow a user to place fingers of both hands therein for gripping the same. Also, more than one recess may be provided and they may be provided in any of the exterior surfaces of the supporting body assembly 12. While an integral handle is described, the present description envisions other kinds of externally oriented handles, such as those that may be attached to the supporting body assembly 12.

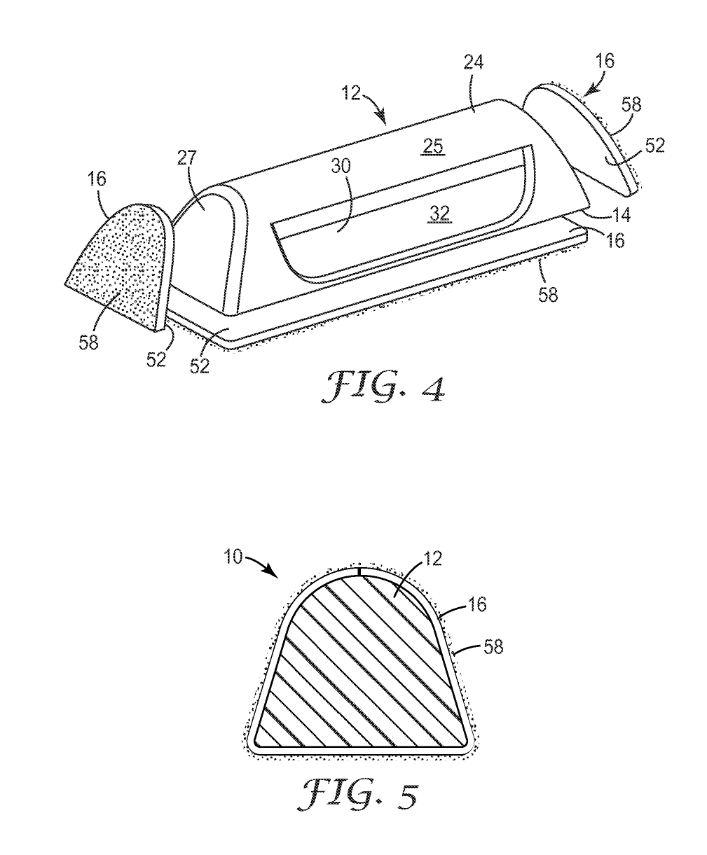

The first major surface 14 as noted is generally planar. The first major surface 14 may be coupled to a generally planar attaching layer 40 (see FIGS. 1-3) that is to be interposed between the supporting body assembly 12 and surface modifying article 16. Alternatively, the attaching layer may not be used and the first major surface 14 is adapted to be releasably directly connected to and a surface modifying article 16 (see FIG. 4). The attaching layer 40 may have the same size and shape as the first major surface 14 and a surface modifying article 16 coupled thereto.

For effectuating the releasable connection contemplated by the present description, the attaching layer 40 is adapted to include at least one releasable attachment system on a major surface 42 and as well as on an opposing major surface 43. For example, the present description envisions all kinds of releasable attachment mechanisms, including, but not limited, to a wide variety of reclosable fasteners such as hook and loop fastening elements or mechanisms or the like. Some fastening elements include solid protrusions including a stem and an expanded region or head that may take a variety of shapes. Exemplary patents describing this latter type of a fastener include: U.S. Pat. Nos. 3,192,589, and 5,097,570. Another type of fastening element includes a multiplicity intermeshing solid protrusions are described in U.S. Pat. No. 4,875,259. An example of a suitable hook and loop mechanism is commercially available from 3M Company, St. Paul, Minn. under the trade name designations Hookit™ and Hookit™ II. Other suitable configurations of hook and loop attachments are within the scope of the present disclosure. Also, any suitable adhesive system including any kind of pressure-sensitive adhesive may be used instead of the mechanical reclosable-type arrangements.

In the present exemplary embodiment, the one major surface 42 may be provided with a pressure sensitive adhesive material that would releasably attach to the first major surface 14. The first major surface 14 may also be provided with hooks and/or loops of a hook and loop system. Likewise, the opposing major surface 43 may be constructed in a similar fashion as the one major surface with a pressure sensitive material or hooks 45 of a hook and loop mechanical fastening arrangement. The releasable attachment systems for both the surfaces may be the same or dissimilar in terms of their constructions.

The surface modifying article 16 of the exemplary embodiment may be a flexible resilient foam abrasive element or pad 16 that includes a foam backed layer 52 defining a first major surface 54 and opposing thereto an abrasive layer 56 defining a second major surface 58. The foam backed layer may be a generally flexible material made of a polymeric material. One kind of foam material may be flexible polyurethane that is open cell in formation.

The thickness of the surface modifying article 16 may be in a range that permits it to conform and be generally coextensive with the surface it is to cover. In the illustrated embodiment the thickness may range from about 1 mm to about 5 mm. Its flexible and releasable characteristics allow such a surface modifying article to be easily removed and replaced. Advantageously, this enhances versatility because the supporting body assembly 12 may have several different surface treating characteristics because several different surface modifying articles may be used. The materials forming the foam backed layer 52 may be selected from a group of materials consisting of: synthetic polymers, polyurethane, Neoprene™, styrenebutadiene rubber, polyethylene, acrylic foam, and combinations thereof. One example of such an abrasive pad is commercially available from 3M Corporation, St. Paul, Minn. and sold under the trade name Sandmaster™.

It will be appreciated in FIG. 5, the flexible foam abrasive element 16 may be wrapped around all or a portion of the periphery of the supporting body assembly 12. In this regard, the flexible foam abrasive element 16 as described above may be permanently retained or releasably retained using an appropriate releasable attachment system of the kinds described above. In FIG. 4, selected portions or additional portions of the supporting body assembly 12, such as the end portions 27 may have similarly shaped and sized surface modifying articles 16, as described above, secured thereto.

This present description may take on various modifications and alterations without departing from the spirit and scope. Accordingly, the present description is not limited to the above-described embodiments, but is to be controlled by limitations set forth in the following claims and any equivalents thereof. This present description also may be suitably practiced in the absence of any element not specifically disclosed herein. All patents and publications noted above, including any in the Background section are incorporated by reference into this document in total.

What is claimed is:

1. A non-motorized hand manipulatable surface modifying tool, the tool comprising:
a generally lightweight, low density supporting body assembly including at least a first major surface and being made of a block of generally rigid plastic foam material that is sized and shaped to allow a user to manipulate the tool by hand to modify a surface while retaining its shape under hand applying pressure; and
a generally flexible surface modifying article that is releasably connected to at least the first major surface so as to be generally coextensive with at least a portion thereof.

2. The tool of claim 1, wherein the block of rigid plastic foam material includes at least one material from a group of materials consisting of polystyrenes, polyurethanes, polyurethanes, polyesters, polymeric foams, and combinations thereof.

3. The tool of claim 2, wherein the rigid plastic foam material has a density in a range of about 2.5 pounds/ft.³ to about 6.0 pounds/ft.³.

4. The tool of claim 1, further including an attaching member interposed between the surface modifying article and supporting body assembly, the attaching member has one major surface releasably joined to the first major surface and another major surface releasably joined to the surface modifying article.

5. The tool of claim 4, wherein the attaching member includes elements of a releasable fastening mechanism connected to the one major surface for releasable fastening to first major surface, and elements of a releasable fastening mechanism on the another major surface for releasable fasten to the surface modifying article.

6. The tool of claim 1, wherein the surface modifying article includes a flexible foam backing layer on a first major surface thereof and an abrasive layer on a second major surface thereof which is opposing the first major surface of the surface modifying article, the foam backing layer is connected to and conformable with at least the first major surface of the supporting body assembly and the abrasive layer is adapted to modify a working surface.

7. The tool of claim 6, wherein the abrasive layer is coated on the foam backing layer.

8. The tool of claim 6, wherein the foam backing layer has a density that is less than the density of the rigid plastic foam material.

9. The tool of claim 7, wherein foam backing layer generally matches the shape and size of the first major surface of the supporting body assembly and is generally coextensive therewith.

10. The tool assembly of claim 1, wherein the supporting body assembly including the first major surface has a shape and size contoured to meet surface modifying characteristics of a working surface.

11. The tool of claim 1, wherein the supporting body assembly includes a handle.

12. The tool of claim 11, wherein the handle comprises at least one recess in an exterior surface thereof for allowing a user to utilize the recess as a handle for gripping supporting body assembly.

13. The tool of claim 6, wherein the supporting body assembly includes at least an additional major surface in addition to the first major surface, wherein the foam backing layer is conformable with and connected to the additional major surface so as to be generally coextensive therewith.

14. The tool of claim 1, wherein the supporting body assembly includes a releasable mechanical attachment layer thereon that releasably is attachable to one of the one major surface of the attaching member and first major surface of the surface modifying article.

15. The tool of claim 14, wherein the plastic foam backing layer is made of at least one material from a group of materials consisting of synthetic polymers, polyurethanes, Neoprene™, styrenebutadiene rubber, polyethylenes, acrylic foams, and combinations thereof.

16. The tool of claim 1, wherein the surface modifying article has a thickness in a range of about 1 mm to about 5 mm.

17. The tool of claim 10, wherein the surface modifying article has a releasable mechanical attachment element on one major surface and an abrasive surface on an opposing major surface thereof.

18. A method of converting of a non-motorized hand manipulatable surface modifying tool, the method comprising:
providing a generally lightweight, low density supporting body assembly including at least a first major surface and being made of a block of generally rigid plastic foam material that is sized and shaped to allow a user to manipulate the tool by hand to modify a surface while retaining its shape under hand applying pressure; and a generally flexible surface modifying article that is releasably connected to at least the first major surface so as to be generally coextensive with at least a portion thereof;
removing the surface modifying article by peeling the surface modifying article from the supporting body assembly; and
attaching another surface modifying article to the first major surface.

19. The method of claim 18, further comprising: providing an attaching member to be interposed between the surface modifying article and supporting body assembly, the attaching member has one major surface releasably joined to the first major surface and another major surface releasably joined to the surface modifying article.

20. The method of claim 18, wherein the providing includes providing the block of rigid plastic foam material from a group of materials consisting of polystyrenes, polyurethanes, polyurethanes, polyesters, polymeric foams, and combinations thereof and combinations thereof, wherein the rigid plastic foam material has a density in a range of about 2.50 pounds/ft.³ to about 6.00 pounds/ft.³.
